(19) United States
(12) Patent Application Publication
(10) Pub. No.: US 2022/0239085 A1
(43) Pub. Date: Jul. 28, 2022

(54) RECESSED ELECTRICAL OUTLET

(71) Applicant: Damian Cousins, Columbia, SC (US)

(72) Inventor: Damian Cousins, Columbia, SC (US)

(21) Appl. No.: 17/574,631

(22) Filed: Jan. 13, 2022

Related U.S. Application Data
(60) Provisional application No. 63/141,029, filed on Jan. 25, 2021.

(51) Int. Cl. H02G 3/10; H01R 24/76; H02G 3/18

(52) U.S. Cl. CPC H02G 3/10; H02G 3/18; H01R 24/76

(57) ABSTRACT

A recessed electrical outlet removably disposed within at least a portion of a wall, the recessed electrical outlet including a receptacle box, including a first recessed surface recessed with respect to an outer surface of the receptacle box, and a second recessed surface disposed on at least a portion of the first recessed surface and recessed with respect to the outer surface of the receptacle box, and at least one socket disposed on at least a portion of the first recessed surface to receive at least one external plug therein.

### CROSS-REFERENCE TO RELATED APPLICATIONS

This application claims priority under 35 USC § 120 from U.S. Provisional Application No. 63/141,029, entitled “Recessed Electrical Outlet,” which was filed on Jan. 25, 2021, in the United States Patent and Trademark Office, the disclosure of which is incorporated herein in its entirety by reference.

### BACKGROUND

### 1. Field

The present general inventive concept relates generally to an electrical outlet, and particularly, to a recessed electrical outlet.

### 2. Description of the Related Art

An electrical socket is a common piece of equipment in a building that connects electrical equipment to a power supply. The type of the electrical socket may differ in voltage and/or current rating.

However, the electrical socket generally shows the same façade with two and/or three pin sockets exposed, such that a large plug inserted into one of the sockets will extend away from the socket. As such, the protruding plug limits placement of furniture around the plug and cord.

Therefore, there is a need for a recessed electrical outlet that adjusts a position of the plug, such that only the cord is exposed.

### SUMMARY

The present general inventive concept provides a recessed electrical outlet.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a recessed electrical outlet removably disposed within at least a portion of a wall, the recessed electrical outlet including a receptacle box, including a first recessed surface recessed with respect to an outer surface of the receptacle box, and a second recessed surface disposed on at least a portion of the first recessed surface and recessed with respect to the outer surface of the receptacle box, and at least one socket disposed on at least a portion of the first recessed surface to receive at least one external plug therein.

The first recessed surface may be angularly disposed away from at least a portion of the outer surface of the receptacle box and angularly disposed away from at least a portion of the second recessed surface at a center portion of the receptacle box.

The first recessed surface and the second recessed surface may form a V-shape with respect to an entirety of the outer surface of the receptacle box.

The first recessed surface may prevent the at least one external plug from being visible with respect to a side elevation view of the receptacle box while the at least one external plug is connected to the at least one socket.

The recessed electrical outlet may further include at least one USB port removably disposed on at least a portion of the first recessed surface to receive the at least one external plug therein.

The recessed electrical outlet may further include at least one cable port removably disposed on at least a portion of the first recessed surface to receive the at least one external plug therein.

The recessed electrical outlet may further include a light linearly disposed on at least a portion of the first recessed surface to illuminate a surrounding area thereof.

The recessed electrical outlet may further include a control panel disposed on at least a portion of the first recessed surface and comprising at least one socket switch, the control panel to turn on the at least one socket in response to depressing the at least one socket switch a first time, and turn off the at least one socket in response to depressing the at least one socket switch a second time.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front perspective view of a recessed electrical outlet including two three-pin sockets, according to an exemplary embodiment of the present general inventive concept;

FIG. 1B illustrates a front perspective view of the recessed electrical outlet including a three-pin socket and two USB ports, according to an exemplary embodiment of the present general inventive concept;

FIG. 10 illustrates a front perspective view of the recessed electrical outlet including three three-pin sockets and a cable port, according to an exemplary embodiment of the present general inventive concept; and

FIG. 2 illustrates a sectional view of an interior of the recessed electrical outlet, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Recessed Electrical Outlet 100

Receptacle Box 110

First Recessed Surface 111

Second Recessed Surface 112

Sockets 120

Universal Serial Bus Ports 130

Cable Port 140

Light 150

Control Panel 160

Socket Switch 161

Light Switch 162

Exterior Plate 170

Plate Fasteners 171

Connecting Cover 180

Springs 181

Liquid Sensor 190

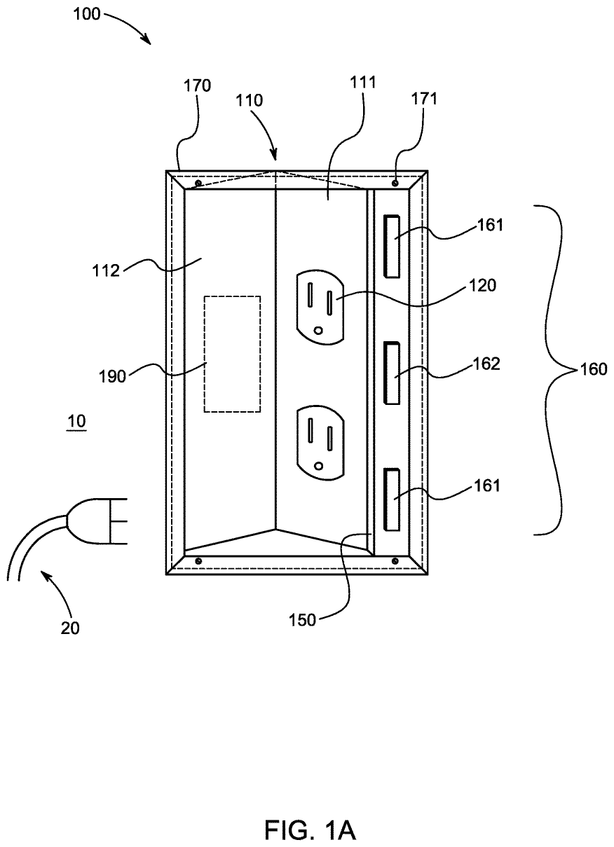

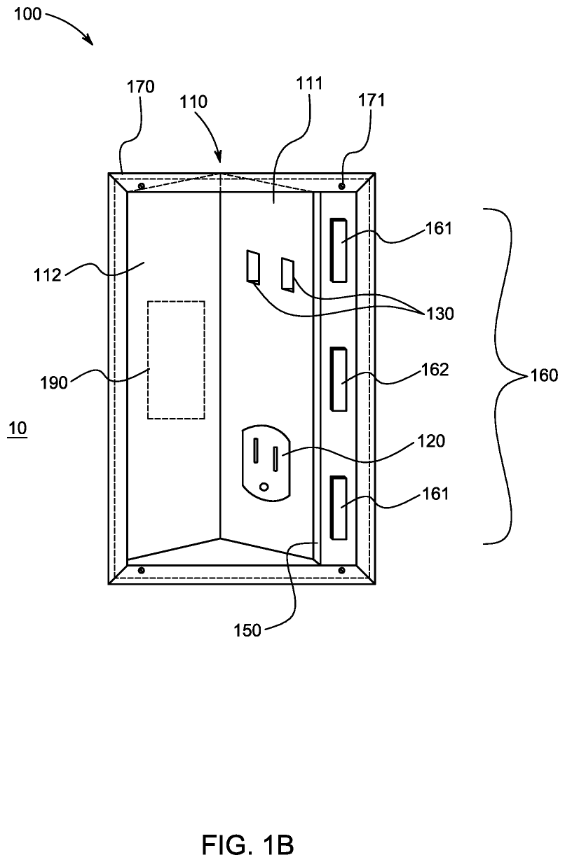

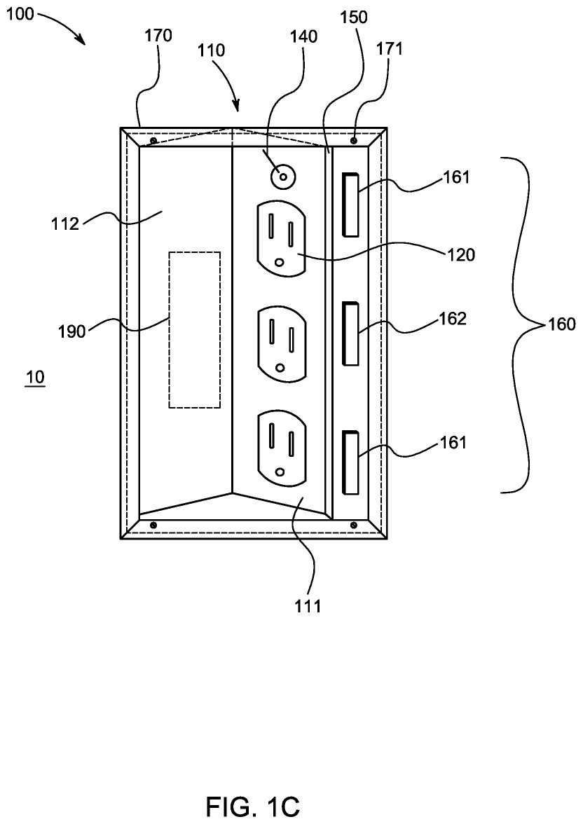

FIG. 1A illustrates a front perspective view of a recessed electrical outlet 100 including two three-pin sockets 120, according to an exemplary embodiment of the present general inventive concept.

FIG. 1B illustrates a front perspective view of the recessed electrical outlet 100 including a three-pin socket 120 and two USB ports 130, according to an exemplary embodiment of the present general inventive concept.

FIG. 1C illustrates a front perspective view of the recessed electrical outlet 100 including three three-pin sockets 120 and a cable port 140, according to an exemplary embodiment of the present general inventive concept.

FIG. 2 illustrates a sectional view of an interior of the recessed electrical outlet 100, according to an exemplary embodiment of the present general inventive concept.

The recessed electrical outlet 100 may be constructed from at least one of metal, plastic, wood, glass, and rubber, etc., but is not limited thereto. Moreover, the recessed electrical outlet 100 may be waterproof, such that the recessed electrical outlet 100 may prevent water from moving therein.

Referring to FIGS. 1A through 2, the recessed electrical outlet 100 may include a receptacle box 110, a plurality of sockets 120, a plurality of universal serial bus (USB) ports 130, at least one cable port 140, a light 150, a control panel 160, an exterior plate 170, a connecting cover 180, and a liquid sensor 190, but is not limited thereto.

Referring again to FIGS. 1A through 2, the receptacle box 110 is illustrated to have a rectangular shape. However, the receptacle box 110 may be a rectangular prism, circular, conical, triangular, pentagonal, hexagonal, heptagonal, octagonal, or any other shape known to one of ordinary skill in the art, but is not limited thereto.

The receptacle box 110 may include a first recessed surface 111 and a second recessed surface 112, but is not limited thereto.

The receptacle box 110 may be removably disposed within at least a portion of a wall 10. Moreover, the first recessed surface 111 and/or the second recessed surface 112 may be recessed with respect to an outer surface and/or an entire outer edge (i.e. an outer perimeter) of the receptacle box 110. As such, the first recessed surface 111 and/or the second recessed surface 112 may be recessed with respect to the wall 10.

Also, the first recessed surface 111 may be angularly disposed away from at least a portion of the entire outer edge of the receptacle box 110 and angularly disposed away from at least a portion of the second recessed surface 112 at a center portion of the receptacle box 110. Similarly, the second recessed surface 112 may be angularly disposed away from at least another portion of the entire outer edge of the receptacle box 110 and angularly disposed away from at least a portion of the first recessed surface 112 at the center portion of the receptacle box 110. In other words, the first recessed surface 111 and/or the second recessed surface 112 may bend toward the center portion of the receptacle box 110, such that the first recessed surface 111 and/or the second recessed surface 112 may form a V-shape with respect to the entire outer edge of the receptacle box 110.

Each of the plurality of sockets 120 may include a three-pin socket and a two-pin socket, but is not limited thereto. Alternatively, and/or in addition thereto, any other number of pin sockets may be used. Although, the plurality of sockets 120 is described in plurality, only a single socket 120 may be used.

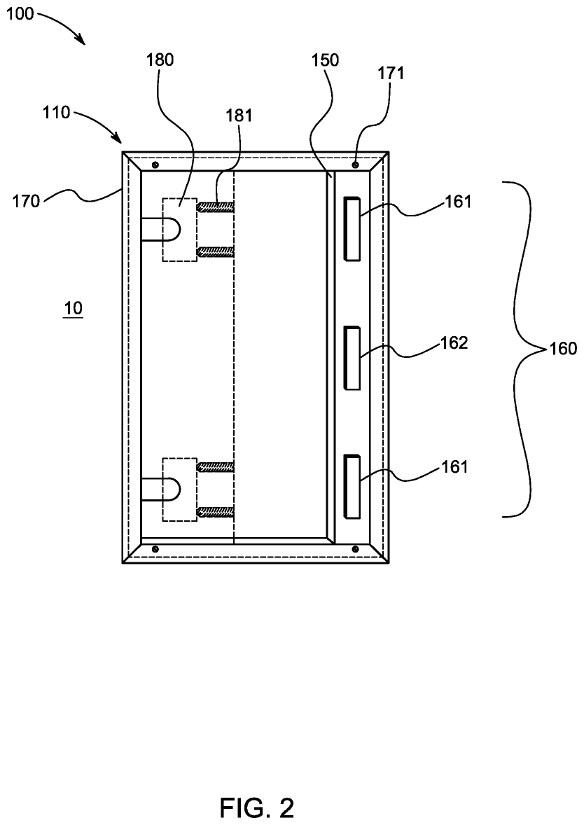

Referring to FIGS. 1A through 10, the plurality of sockets 120 may be removably disposed on at least a portion of the first recessed surface 111. Moreover, each of the plurality of sockets 120 may receive at least one external plug 20 (e.g., a two-prong plug, a three-prong plug, a USB plug, a cable plug, etc.) to connect thereto, such that the plurality of sockets 120 sends power to the at least one external plug 20. Due to the position of the first recessed surface 111 and/or the second recessed surface 112, each of the plurality of sockets 120 connected to the at least one external plug 20 may be angularly disposed in a similar direction as the first recessed surface 111, such that the at least one external plug 20 may not extend perpendicularly with respect to the wall 10. In other words, the first recessed surface 111 and/or the plurality of sockets 120 may prevent the at least one external plug 20 from being visible with respect to a side elevation view of the receptacle box 110, such as viewing the entire outer edge of the receptacle box 110 while disposed within the wall 10. Accordingly, only a cord of the at least one external plug 20 may be visible.

Each of the plurality of USB ports 130 may include a USB 1.0 port, a USB 2.0 port, a USB 3.0 port, a USB-C port, and a USB4 port, but is not limited thereto. Although, the plurality of USB ports 130 is described in plurality, only a single USB port 130 may be used.

Referring to FIG. 1B, the plurality of USB ports 130 may be removably disposed on at least a portion of the first recessed surface 111. Moreover, each of the plurality of USB ports 130 may receive the at least one external plug 20 to connect thereto, such that the plurality of USB ports 130 sends power to the at least one external plug 20. Due to the position of the first recessed surface 111 and/or the second recessed surface 112, each of the plurality of USB ports 130 connected to the at least one external plug 20 may be angularly disposed in a similar direction as the first recessed surface 111, such that the at least one external plug 20 may not extend perpendicularly with respect to the wall 10. In other words, the first recessed surface 111 and/or the plurality of USB ports 130 may prevent the at least one external plug 20 from being visible with respect to a side elevation view of the receptacle box 110, such as viewing the entire outer edge of the receptacle box 110 while disposed within the wall 10.

The at least one cable port 140 may include a coaxial connector (e.g., an F-type connector), but is not limited thereto. Alternatively, and/or in addition thereto, any other type of coaxial connectors may be used.

Referring to FIGS. 1A through 10, the at least one cable port 140 may be removably disposed on at least a portion of the first recessed surface 111. Moreover, the at least one cable port 140 may receive the at least one external plug 20 to connect thereto, such that the at least one cable port 140 sends power and/or a signal (e.g., cable, satellite, etc.) to the at least one external plug 20. Due to the position of the first recessed surface 111 and/or the second recessed surface 112, the at least one cable port 140 connected to the at least one external plug 20 may be angularly disposed in a similar direction as the first recessed surface 111, such that the at least one external plug 20 may not extend perpendicularly with respect to the wall 10. In other words, the first recessed surface 111 and/or the at least one cable port 140 may prevent the at least one external plug 20 from being visible with respect to a side elevation view of the receptacle box 110, such as viewing the entire outer edge of the receptacle box 110 while disposed within the wall 10.

Accordingly, any of the plurality of sockets 120, the plurality of USB ports 130, and/or the at least one cable port 140 may be exchanged for the components based on a preference of a user and/or a manufacturer.

Furthermore, a size (i.e. length, width, height) of the receptacle box 110 may be adjusted based on a size of the at least one external plug 20, such that the at least one external plug 20 may be hidden as described above.

The light 150 may be linearly disposed on at least a portion of the receptacle box 110. More specifically, the light 150 may linearly extend from a first edge of the receptacle box 110 to a second edge of the receptacle box 110 opposite with respect to the first edge of the receptacle box 110. Accordingly, the light 150 may illuminate a surrounding area of the receptacle box 110. Furthermore, the light 150 may be visible with respect to a side elevation view of the receptacle box 110, such as viewing the entire outer edge of the receptacle box 110 and/or the wall 10. As such, the light 150 may operate as a nightlight.

The control panel 160 may include at least one socket switch 161 and a light switch 162, but is not limited thereto.

The control panel 160 may be disposed on at least a portion of the receptacle box 110. Moreover, the at least one socket switch 161 may turn on at least one of the plurality of sockets 120, at least one of the plurality of USB ports 130, and/or the at least one cable port 140 in response to depressing the at least one socket switch 161 a first time, and turn off at least one of the plurality of sockets 120, at least one of the plurality of USB ports 130, and/or the at least one cable port 140 in response to depressing the at least one socket switch 161 a second time. In other words, the at least one socket switch 161 may be used to turn on and/or turn off the power of at least one of the plurality of sockets 120, at least one of the plurality of USB ports 130, and/or the at least one cable port 140.

Also, the light switch 162 may turn on the light 150 in response to depressing the light switch 162 a first time, and turn off the light 150 in response to depressing the light switch 162 a second time. In other words, the at least one socket switch 161 may be used to turn on and/or turn off the power of the light 150.

The exterior plate 170 may include a plurality of plate fasteners 171 (e.g., a screw, a nail, a bolt, a washer, an adhesive, a magnet, etc.), but is not limited thereto.

The exterior plate 170 may be removably connected to the wall 10 via the plurality of plate fasteners 171. The exterior plate 170 may cover the entire outer edge of the receptacle box 110 as oriented against the wall 10.

The connecting cover 180 may include a plurality of springs 181, but is not limited thereto.

The connecting cover 180 may be disposed on at least a portion of the receptacle box 110. The connecting cover 180 may removably connect the receptacle box 110 within the wall using the plurality of springs 181. Additionally, the plurality of springs 181 may prevent damage to the receptacle box 110 within the wall 10.

The liquid sensor 190 may include a circuit breaker, but is not limited thereto.

The liquid sensor 190 may be disposed on at least a portion of the receptacle box 110 behind the wall 10. Moreover, the liquid sensor 190 may disable an electrical connection between the plurality of sockets 120, the plurality of USB ports 130, the at least one cable port 140, the light 150, and/or the control panel 160 in response to detecting a liquid (e.g., water) on the receptacle box 110, the plurality of sockets 120, the plurality of USB ports 130, the at least one cable port 140, the light 150, the control panel 160, the exterior plate 170, the connecting cover 180, and/or the liquid sensor 190. As such, the liquid sensor 190 may prevent electrical damage thereto due to the liquid.

Therefore, the recessed electrical outlet 100 may adjust the position of the external plug 20 to prevent it from protruding away from the wall 10. As such, the recessed electrical outlet 100 may facilitate organization of furniture around the recessed electrical outlet 100.

The present general inventive concept may include a recessed electrical outlet 100 removably disposed within at least a portion of a wall 10, the recessed electrical outlet 100 including a receptacle box 110, including a first recessed surface 111 recessed with respect to an outer surface of the receptacle box 110, and a second recessed surface 112 disposed on at least a portion of the first recessed surface 111 and recessed with respect to the outer surface of the receptacle box 110, and at least one socket 120 disposed on at least a portion of the first recessed surface 111 to receive at least one external plug 20 therein.

The first recessed surface 111 may be angularly disposed away from at least a portion of the outer surface of the receptacle box 110 and angularly disposed away from at least a portion of the second recessed surface 112 at a center portion of the receptacle box 110.

The first recessed surface 111 and the second recessed surface 112 may form a V-shape with respect to an entirety of the outer surface of the receptacle box 110.

The first recessed surface 111 may prevent the at least one external plug 20 from being visible with respect to a side elevation view of the receptacle box 110 while the at least one external plug 20 is connected to the at least one socket 120.

The recessed electrical outlet 100 may further include at least one USB port 130 removably disposed on at least a portion of the first recessed surface 111 to receive the at least one external plug 20 therein.

The recessed electrical outlet 100 may further include at least one cable port 140 removably disposed on at least a portion of the first recessed surface 111 to receive the at least one external plug 20 therein.

The recessed electrical outlet 100 may further include a light 150 linearly disposed on at least a portion of the first recessed surface 111 to illuminate a surrounding area thereof.

The recessed electrical outlet 100 may further include a control panel 160 disposed on at least a portion of the first recessed surface 111 and comprising at least one socket switch 120, the control panel 160 to turn on the at least one socket 120 in response to depressing the at least one socket switch 161 a first time, and turn off the at least one socket 120 in response to depressing the at least one socket switch 161 a second time.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A recessed electrical outlet removably disposed within at least a portion of a wall, the recessed electrical outlet comprising:
a receptacle box, comprising:
a first recessed surface recessed with respect to an outer surface of the receptacle box, and
a second recessed surface disposed on at least a portion of the first recessed surface and recessed with respect to the outer surface of the receptacle box; and
at least one socket disposed on at least a portion of the first recessed surface to receive at least one external plug therein.

2. The recessed electrical outlet of claim 1, wherein the first recessed surface is angularly disposed away from at least a portion of the outer surface of the receptacle box and angularly disposed away from at least a portion of the second recessed surface at a center portion of the receptacle box.

3. The recessed electrical outlet of claim 1, wherein the first recessed surface and the second recessed surface form a V-shape with respect to an entirety of the outer surface of the receptacle box.

4. The recessed electrical outlet of claim 1, wherein the first recessed surface prevents the at least one external plug from being visible with respect to a side elevation view of the receptacle box while the at least one external plug is connected to the at least one socket.

5. The recessed electrical outlet of claim 1, further comprising:
at least one USB port removably disposed on at least a portion of the first recessed surface to receive the at least one external plug therein.

6. The recessed electrical outlet of claim 1, further comprising:
at least one cable port removably disposed on at least a portion of the first recessed surface to receive the at least one external plug therein.

7. The recessed electrical outlet of claim 1, further comprising:
a light linearly disposed on at least a portion of the first recessed surface to illuminate a surrounding area thereof.

8. The recessed electrical outlet of claim 1, further comprising:
a control panel disposed on at least a portion of the first recessed surface and comprising at least one socket switch, the control panel to turn on the at least one socket in response to depressing the at least one socket switch a first time, and turn off the at least one socket in response to depressing the at least one socket switch a second time.
